(19) United States
(12) Patent Application Publication
(10) Pub. No.: US 2008/0182076 A1
(43) Pub. Date: Jul. 31, 2008

(54) SURFACE LUMINOUS BODY, MANUFACTURING METHOD OF THE SAME, DISPLAY DEVICE AND ILLUMINATING DEVICE USING THE SAME

(76) Inventors: Toshiya KONDO, Tokyo (JP); Manami Kuiseko, Kyoto-shi (JP); Akira Sato, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/017,800

(22) Filed: Jan. 22, 2008

(30) Foreign Application Priority Data
Jan. 25, 2007 (JP) JP2007-014796

(51) Int. Cl. B32B 3/00; B29C 65/00

(52) U.S. Cl. 428/172; 156/304.1

(57) ABSTRACT

A surface luminous body having at least a surface luminous element and a light regulating sheet characterized in that the light regulating sheet has a plurality of protrusions at least on one side thereof, and ends of the protrusions are in contact with an light outgoing surface of the surface luminous element via an adhesion layer, and the adhesion layer has one or more pressure-sensitive adhesion layers composed of one or more kinds of pressure-sensitive adhesives, and the ends of the protrusions are embedded partially into the adhesion layer, and the average thickness of the one or more pressure-sensitive adhesion layers between the ends of the protrusions and the light outgoing surface of the surface luminous element is less than 50% of the total thickness of at least one pressure-sensitive adhesion layer composed of at least one kind of pressure-sensitive adhesive.

This application is based on Japanese Patent Application No. 2007-014796 filed on Jan. 25, 2007 in Japanese Patent Office, the entire content of which is hereby incorporated by reference.

### BACKGROUND OF THE INVENTION

The present invention relates to a surface luminous body, a manufacturing method thereof, and a display device and an illuminating device using it.

In recent years, in correspondence with diversification of information equipment, there is an increasing need for a surface luminous element requiring little consumption power and of a small size and as one of such surface luminous elements, an electroluminescence element (hereinafter, abbreviated to an EL element) is noticed.

And, such an EL element is broadly divided into an inorganic EL element and an organic EL element depending to the material used.

Here, the inorganic EL element is generally structured so as to make a high electric field act on the luminous section, accelerate electrons in the high electric field to collide with the light emission center, thereby excite the light emission center to emit light. On the other hand, the organic EL element is structured so as to inject electrons and holes from the electron injection electrode and hole injection electrode into the luminous layer respectively, bind the electrons and holes which are injected in this way in the luminous layer to excite the organic material, and permit the organic material to emit light when it is returned from the excitation state to the basic state. Compared with the inorganic EL element, there is an advantage that the organic material can be driven at a low voltage, and using an advantage of light emission from the surface, an expansion as a thin and flexible illumination use is expected.

Further, in the case of the organic EL element, by selecting a luminous material, a luminous element for emitting light of a suitable color can be obtained, and by a suitable combination of luminous materials, white light can be obtained, thus use as backlight of a liquid crystal display device or the like is also expected.

When using a luminous body as illumination, low power consumption is required and generally, brightness of about 50 lm/W is desired. However, when permitting a surface luminous element such as an inorganic or organic EL element to emit light, rays of light emitted inside the luminous layer and having a high refractive index travel in various directions and there are many rays which are reflected totally on the light outgoing surface of the surface luminous element and are trapped therein. Generally, only 20 to 30% of the light emitted from the surface luminous element can be taken out outside the surface luminous element. The brightness of the inorganic EL element or organic EL element, even if it is an element having high brightness, is 30 to 40 lm/W or so and a problem arises that sufficient brightness cannot be obtained.

Further, when using an EL element as backlight of a liquid crystal display device or the like, generally, front brightness of 2000 to 4000 cd/m² or so is necessary, though as mentioned above, there are many rays trapped inside the surface luminous element, and it is difficult to obtain sufficient front brightness. Particularly, in the case of the organic EL element, to obtain a sufficient light emission life, a problem arises that only front brightness of 1000 to 1500 cd/m² or so is obtained.

Conventionally, when the surface luminous element such as the organic EL element emits light, to take out rays trapped therein and improve the front brightness thereof, an EL element having a diffusion structure installed on the light outgoing surface of the surface luminous element (for example, refer to Patent Document 1) and an EL element having a prism or a lens-shaped sheet attached to the light outgoing surface of the surface luminous element so as to reveal irregularities on the surface thereof have been proposed (for example, refer to Patent Document 2).

However, as mentioned above, when fine irregularities are formed on the light outgoing surface of the surface luminous element or a plane member having irregularities formed on the light outgoing surface of the surface luminous element is attached so as to reveal the irregularities on the surface, a problem arises that light is scattered due to the irregularities on the surface and the front brightness cannot be still improved sufficiently. As another means for improving the front brightness of the surface luminous element such as an organic EL luminous device, a constitution is designed that on the luminous surface, a prism array sheet having irregularities on the surface thereof is installed so that the prism side faces the light outgoing surface (for example, refer to Patent Documents 3, 4). As an adhering method of the prism array sheet to a substrate, a method for adhering with ultraviolet curing resin is proposed. However, a problem arises that it is difficult to coat uniformly ultraviolet curing resin on the substrate. Further, for curing by irradiation of ultraviolet rays, a problem arises that the prism array sheet is limited to a material for transmitting ultraviolet rays. Further, when using it for the organic EL luminous device, another problem arises that irradiation of ultraviolet rays for curing deteriorates the organic material.

As an adhering method of the prism array sheet to the substrate, a method for using an adhesive and a pressure-sensitive adhesive on the bonding surfaces (for example, refer to Patent Document 5) and a method for installing an intermediate film between the prism array sheet and the light outgoing surface of the surface luminous element and bonding the two on both sides thereof using an adhesive (for example, refer to Patent Document 6) are reported. However, in the means using an adhesive, a problem arises that the adhering step is complicated. On the other hand, in the method using a pressure-sensitive adhesive, although the adhering step is simple, the preservation property at high temperature or high humidity is not sufficient still and separation of the adhered surfaces due to a difference in the coefficient of thermal expansion between the materials composing the prism array sheet and surface luminous element, uplifting of the prism array sheet from the adhered surface, and change in the light take-out efficiency and front brightness due to an increase in the embedding depth of the prism into the adhesion layer are caused easily, resulting in a problem in a practical application. Further, when external pressure is applied after adhesion, the embedding depth of the prism array sheet into the adhesion layer is increased, thus a problem arises that uneven brightness is caused easily.

Further, the embedding depth of the prism in the prism array sheet varies with uneven adhering pressure at the adhering step, which causes a problem that uneven brightness is caused easily.

Patent Document 1: Unexamined Japanese Patent Application Publication No. 2000-323272

Patent Document 2: Unexamined Japanese Patent Application Publication No. 6-265888

Patent Document 3: Unexamined Japanese Patent Application Publication No. 2000-148032

Patent Document 4: Unexamined Japanese Patent Application Publication No. 2006-59543

Patent Document 5: Unexamined Japanese Patent Application Publication No. 2001-357709

Patent Document 6: Unexamined Japanese Patent Application Publication No. 2001-356704

### SUMMARY

The present invention is intended, in a surface luminous body having a surface luminous element and a display device and a lighting device using the surface luminous body, to improve greatly the take-out efficiency of light emitted from the surface luminous body and the front brightness.

Furthermore, the present invention is intended to provide a surface luminous body which keeps a stable adhesion state and realizing little change in the light take-out efficiency and front brightness, even when it is preserved in an environment of high temperature and high humidity and even when it is further applied with external pressure, and a manufacturing method thereof.

The aforementioned problems of the present invention can be solved by the following constitution.

1. A surface luminous body having at least a surface luminous element and a light regulating sheet characterized in that the light regulating sheet has a plurality of protrusions at least on one side thereof, and the ends of the protrusions are in contact with the light outgoing surface of the surface luminous element via the adhesion layer, and the adhesion layer has one or more pressure-sensitive adhesion layers composed of one or more kinds of pressure-sensitive adhesive, and the ends of the protrusions are embedded partially into the adhesion layer, and the average thickness of the one or more pressure-sensitive adhesion layers between the ends of the protrusions and the light outgoing surface of the surface luminous element is less than 50% of the total thickness of the one or more pressure-sensitive adhesion layers composed of one or more kinds of pressure-sensitive adhesive.

2. The surface luminous body stated in aforementioned Item 1, characterized in that the adhesion layer includes a pressure-sensitive adhesion layer composed of at least one kind of pressure-sensitive adhesive in contact with the surface luminous element, at least one resin layer, and a pressure-sensitive adhesion layer composed of at least one kind of pressure-sensitive adhesive in contact with the light regulating sheet.

3. The surface luminous body stated in aforementioned Item 2, characterized in that a pressure-sensitive adhesion layer composed of at least one kind of pressure-sensitive adhesive in contact with the surface luminous element and a pressure-sensitive adhesion layer including at least one kind of pressure-sensitive adhesive in contact with the light regulating sheet have different prism embedding loads.

4. The surface luminous body stated in any one of aforementioned Items 1 to 3, characterized in that each of the protrusions has a shape of a truncated cone.

5. A manufacturing method of a surface luminous body having at least a surface luminous element and a light regulating sheet having a plurality of protrusions at least on one side thereof characterized by the steps of adhering the ends of the protrusions of the light regulating sheet and the light outgoing surface of the surface luminous element via the adhesion layer including at least one pressure-sensitive adhesion layer in the state that the ends of the protrusions are embedded partially inside the adhesion layer, and embedding more the ends of the protrusions partially into the adhesion layer by heating.

6. A surface luminous body characterized in that it is manufactured by the manufacturing method of the surface luminous body stated in Item 5.

7. A display device characterized in that it uses the surface luminous body stated in any one of Items 1 to 4 or the surface luminous body stated in Item 6.

8. A lighting device characterized in that it uses the surface luminous body stated in any one of Items 1 to 4 or the surface luminous body stated in Item 6.

### BRIEF DESCRIPTION OF THE DRAWINGS

FIGS. 1(a) and 1(b) are drawings each showing an example of the prism array sheet of the present invention.

FIG. 2 is a drawing showing an example of the embodiments of the surface luminous body of the present invention.

FIG. 3 is a schematic view showing outgoing of light by the surface luminous body relating to the present invention.

FIG. 4 is a schematic view showing the constitution of the prism array sheet, pressure-sensitive adhesion layer, and surface luminous element relating to Embodiment 1 of the present invention.

FIG. 5 is a schematic view showing the constitution of the prism array sheet, pressure-sensitive adhesion layer, and surface luminous element relating to Embodiment 1 of the present invention.

FIGS. 6(a) and 6(b) are schematic views of the prism array sheet each having the protrusions in the truncated cone shape with the end side contracted.

FIG. 7 is a schematic view showing the constitution of the prism array sheet, pressure-sensitive adhesion layer, and surface luminous element relating to Embodiment 2 of the present invention.

FIG. 8 is a schematic view showing the constitution of the prism array sheet, pressure-sensitive adhesion layer, and surface luminous element relating to Embodiment 2 of the present invention.

FIG. 9 is a schematic view showing the constitution of the prism array sheet, pressure-sensitive adhesion layer, and surface luminous element relating to Embodiment 3 of the present invention.

FIG. 10 is a schematic view showing the constitution of the prism array sheet, pressure-sensitive adhesion layer, and surface luminous element relating to Embodiment 3 of the present invention.

### DETAILED DESCRIPTION OF THE PREFERRED EMBODIMENTS

Hereinafter, the preferred embodiments for executing the present invention will be described in detail, though the present invention is not limited to them.

The light regulating sheet used in the present invention is characterized in that it has a plurality of protrusions at least on one side thereof. The sectional shape of the protrusions can be selected optionally from a triangle, a trapezoid, a circular arc, and a rectangle, and the shape and size of the protrusions may be regular or irregular, though the shape and size are preferably a regular truncated quadrangular pyramid or truncated cone and more preferably a regular truncated cone.

According to the present invention, the surface luminous element is characterized in that the ends of the protrusions of the light regulating sheet having a plurality of protrusions at least on one side thereof are in contact with the light outgoing surface of the surface luminous element via the adhesion layer and the adhesion layer has one or more pressure-sensitive adhesion layers composed of one or more kinds of pressure-sensitive adhesives. The adhesion layer has preferably two or more pressure-sensitive adhesion layers and includes more preferably a pressure-sensitive adhesion layer composed of at least one kind of pressure-sensitive adhesive in contact with the surface luminous element, at least one resin layer, and a pressure-sensitive adhesion layer composed of at least one kind of pressure-sensitive adhesive in contact with the light regulating sheet. The at least one resin layer aforementioned is preferably installed between the pressure-sensitive adhesion layer composed of at least one kind of pressure-sensitive adhesive in contact with the light outgoing surface of the surface luminous element and the pressure-sensitive adhesion layer composed of at least one kind of pressure-sensitive adhesive in contact with the light regulating sheet. The at least one resin layer installed between the pressure-sensitive adhesion layer in contact with the light regulating sheet and the pressure-sensitive adhesion layer in contact with the light outgoing surface of the surface luminous element functions as a resistance when force is applied in the embedding direction of the prism, so that at adhering pressure of a certain fixed pressure or higher, the light regulating sheet has a characteristic that the change in the embedding depth of each top of the protrusions becomes smaller suddenly, thus the pressure resistance is improved more.

Further, the pressure-sensitive adhesion layer composed of at least one kind of pressure-sensitive adhesive in contact with the light outgoing surface of the surface luminous element and the pressure-sensitive adhesion layer including at least one kind of pressure-sensitive adhesive in contact with the light regulating sheet have preferably different prism embedding loads, and the ratio B/A of the prism embedding load A of the pressure-sensitive adhesion layer composed of at least one kind of pressure-sensitive adhesive in contact with the light outgoing surface of the surface luminous element and the prism embedding load B of the pressure-sensitive adhesion layer including at least one kind of pressure-sensitive adhesive in contact with the light regulating sheet is preferably within the range of 0<B/A<1, more preferably within the range of 0<B/A<0.7 and further more preferably within the range of 0<B/A<0.5.

The prism embedding load to the pressure-sensitive adhesion layer relating the present invention is a load described as follows. Firstly, a transparent substrate having the pressure-sensitive adhesion layer formed by cutting off and adhering the pressure-sensitive adhesive used for the pressure-sensitive adhesion layer composed of at least one kind of pressure-sensitive adhesive in contact with the light outgoing surface of the surface luminous element and a transparent substrate having the pressure-sensitive adhesion layer formed by cutting off and adhering the pressure-sensitive adhesive used for the pressure-sensitive adhesion layer including at least one kind of pressure-sensitive adhesive in contact with the light regulating sheet are prepared. Secondly a light regulating sheet, which will be described later, having a plurality of protrusions each in a truncated cone shape with a apex angle θ of 50°, a height of 26.6 μm, and a pitch of 35 μm (distance between apexes) at least on one side thereof is cut off in the same area as each other. The prism embedding load to the pressure-sensitive adhesion layer relating the present invention is a load per unit area necessary to embed the protrusions in the truncated cone shape into the pressure-sensitive adhesion layer to an average depth of 5 μm, when making the ends of the protrusions adhere onto the transparent substrate via the pressure-sensitive adhesion layer.

The prism embedding load, more concretely, is obtained by the following method.

The pressure-sensitive adhesion layer is formed on each of the transparent substrates, and then the light regulating sheet is placed on the pressure-sensitive adhesion layer in the state that the protrusions thereof are in contact with the surface of the pressure-sensitive adhesion layer. At a temperature of 25° C. and a relative humidity of 50%, from the other surface of the light regulating sheet, an optional fixed load is immediately added uniformly on the surface using a weight. After holding for 10 seconds, the load is removed immediately, and then the embedding depth of the protrusions into the pressure-sensitive adhesion layer is obtained by the following method. At a different place on the light regulating sheet, the same process is performed by changing the load, and the relationship between the load per unit area obtained at each load and the average protrusion embedding depth at each load is interpolated, thus the prism embedding load is obtained. Here, the average of the protrusion embedding depths at each load is an average of the protrusion embedding depths measured for twenty (20) or more protrusions at even intervals.

According to the present invention, the ends of the protrusions of the light regulating sheet are embedded partially into the adhesion layer, and the average thickness of at least one pressure-sensitive adhesion layer composed of one or more kinds of adhesive between the ends of the protrusions and the light outgoing surface of the surface luminous element is characteristically less than 50% of the total thickness of at least one pressure-sensitive adhesion layer composed of at least one kind of pressure-sensitive adhesive, preferably 35% or less, more preferably 25% or less.

Further, according to the present invention, the total thickness of at least one pressure-sensitive adhesion layer composed of one or more kinds of pressure-sensitive adhesive (hereinafter referred to as the total thickness of pressure-sensitive adhesion layer) is a thickness of pressure-sensitive adhesion layer used when the light regulating sheet is adhered to the light outgoing surface of the surface luminous element and when plural pressure-sensitive adhesion layers are laminated, it is the total sum of thicknesses of the plural pressure-sensitive adhesion layers.

In the present invention, the average thickness of at least one pressure-sensitive adhesion layer composed of one or more kinds of pressure-sensitive adhesives between the ends of the protrusions and the light outgoing surface of the surface luminous element (hereinafter referred to as the average thickness of pressure-sensitive adhesion layer between the ends of the protrusions and the light outgoing surface of the surface luminous element) is an average of the thickness of pressure-sensitive adhesion layer existing between the ends of the protrusions and the light outgoing surface of the surface luminous element while a part of each of the protrusion ends of the light regulating sheet is embedded in the adhesion layer. When plural pressure-sensitive adhesion layers are laminated, the total sum of the thicknesses of these plural pressure-sensitive adhesion layers is the average thickness.

Further, in the present invention, the average thickness of the pressure-sensitive adhesion layer between the ends of the protrusions and the light outgoing surface of the surface luminous element is obtained, according to the following method, by measuring the embedding depth of the protrusions into the adhesion layer or pressure-sensitive adhesion layer with respect to the protrusions existing in the range of 10-30% of the area of the light regulating sheet and by subtracting the average value of the measured embedding depth from the thickness of the pressure-sensitive adhesion layer used at the time when adhering the light regulating sheet. Further when as the adhesion layer, at least one resin layer is combined with one or more pressure-sensitive adhesion layers, the thickness is obtained by subtracting the thickness of the at least one resin layer. The calculation is conducted assuming that the thickness of the at least one resin layer does not change between before and after the adhesion of the light regulating sheet.

The protrusion embedding depth into the adhesion layer or pressure-sensitive adhesion layer is obtained by observing the protrusions embedded in the adhesion layer or pressure-sensitive adhesion layer in the normal line to the transparent substrate using a transmission type optical microscope. The protrusion embedding depth is obtained by reading the image into the image processor, measuring the diameter (X shown in FIGS. 5, 8, and 10) of each of the embedded protrusions on the boundary face with the adhesion layer, and calculating the protrusion embedding depth (Y shown in FIGS. 5, 8, and 10) from the protrusion shape of the light regulating sheet used, including the apex angle θ, height, and pitch “P” of each protrusion.

The surface luminous body relating to the present invention is preferably manufactured by adhering the ends of the protrusions of the light regulating sheet to the light outgoing surface of the surface luminous element in the state that the ends of the protrusions are embedded partially inside the adhesion layer via the adhesion layer including at least one pressure-sensitive adhesion layer and embedding more the ends of the protrusions partially into the adhesion layer by heating. By heating, after the prism is embedded to a stable depth and adhered to the light regulating sheet, even when the surface luminous body is preserved in an environment of high temperature and high humidity or even when it is applied with external force, sufficient adhesive strength is maintained, and the change in the prism embedding depth can be made smaller, thus a surface luminous body having little change in the light take-out efficiency and front brightness can be provided. The heating temperature can be selected appropriately depending on the material and characteristic of the light regulating sheet and pressure-sensitive adhesive or the like used, however it is generally 40° C. or higher, preferably 50 to 200° C., and more preferably 60° C. to 160° C.

The heating aforementioned may be carried out while adhering the ends of the protrusions of the light regulating sheet to the light outgoing surface of the surface luminous element in the state that the ends of the protrusions are embedded partially inside the adhesion layer via the adhesion layer including at least one pressure-sensitive adhesion layer. However, in correspondence to softening of the adhesion layer by heating, variations in the embedding depth of the ends of the protrusions into the adhesion layer due to uneven pressurization during adhesion and uneven adhesion are apt to occur. Thus it is preferable to carry out the heating after adhering the ends of the protrusions of the light regulating sheet to the light outgoing surface of the surface luminous element in the state that the ends of the protrusions are embedded partially inside the adhesion layer via the adhesion layer including at least one pressure-sensitive adhesion layer.

Further, according to the present invention, the difference between the refractive index of the protrusions and the refractive index of each layer composing the adhesion layer is preferably 0.2 or less.

The pressure-sensitive adhesion layers composing the adhesion layer in contact with the light regulating sheet are preferably thin with respect to the height of the protrusions of the light regulating sheet and the protrusion embedding depth is more preferably almost equal to the thickness of the pressure-sensitive adhesion layers. Here, the protrusion embedding depth, when the protrusions are adhered, is a depth of the ends of the protrusions embedded from the surface of the adhesion layer. The adhesion layer in contact with the light regulating sheet is composed of one or more kinds of pressure-sensitive adhesives and may be composed of two or more kinds of pressure-sensitive adhesives. When the protrusion embedding depth is 2 μm or more, it can absorb manufacture errors of the protrusions and can increase the adhesive strength. Further, when it is 4 μm or more, it increases more preferably the effect thereof.

The difference in the thermal expansion coefficient between the light regulating sheet and the adhesion layer is preferably small and the ratio of the thermal expansion coefficient is preferably 1/10 to 10.

The difference in the hydroscopic expansion coefficient between the light regulating sheet and the adhesion layer is preferably small and the ratio of the hygroscopic expansion coefficient is preferably 1/10 to 10.

The pressure-sensitive adhesive of the present invention, widely in the industrial field, among agents or materials used by names such as a pressure-sensitive adhesive or an adhesive, or a pressure-sensitive material or an adhesive material, means one which is adhered by pressurization and accompanies no hardening of the adhering portion. The kind of the pressure-sensitive adhesive used for the pressure-sensitive adhesion layer of the present invention is not restricted particularly, however for example, an acrylic pressure-sensitive adhesive of system of an urethane, an epoxy, an aqueous high polymer molecule-isocyanate, and an anaerobic pressure-sensitive adhesive of type of a polyether methacrylate, an ester methacrylate, and an oxidation polyether methacrylate may be cited. To lead appropriately light outgoing from the light outgoing surface of the surface luminous element to the protrusions of the light regulating sheet, it is preferable to adhere the light regulating sheet with a high light-transmissive pressure-sensitive adhesion layer and an acrylic pressure-sensitive adhesive which is excessively transparent and of strong adhesion is preferable. Further, using a well-known method, an antistatic agent or various fillers may be mixed in the pressure-sensitive adhesive.

The forming method of the pressure-sensitive adhesion layer is not restricted particularly and general methods, for example, methods using a gravure coater, a microgravure coater, a comma coater, a bar coater, a spray coating, and an ink jet method may be cited.

As a resin layer relating to the present invention, relative to the pressure-sensitive adhesive composing the pressure-sensitive adhesion layer in contact with the light regulating sheet, a material which has high hardness and high transparency is used. To be more specific, transparent resin such as PET (polyethylene terephthalate), TAC (triacetyl cellulose), PC (polycarbonate), and PMMA (polymethyl methacrylate) may be cited and it is desirable to use these transparent resin sheets. In addition to the resin sheets, a thin resin layer may be formed on the pressure-sensitive adhesive at the coating step. By using a hard material as a resin layer, when embedding the protrusions of the light regulating sheet into the pressure-sensitive adhesive composing the pressure-sensitive adhesion layer to be in contact with the light regulating sheet, at a certain fixed embedding depth decided from the thickness of the pressure-sensitive adhesive, the embedding load is increased suddenly, thus a highly uniform embedding depth can be obtained inside the surface. Further, a structure in which the embedding depth is hardly changed against external pressure after adhesion is obtained.

Further, when using a resin sheet as a resin layer, to prevent the adhesion condition from deterioration due to the differences in the thermal expansion coefficient and hygroscopic expansion coefficient between the light regulating sheet and the resin sheet and from the recent request of realization of a thin surface luminous body, the thickness of the resin sheet is preferably 80 μm or less, more preferably 30 μm or less. Furthermore, as the resin sheet becomes thinner, upon receipt of tension stress due to expansion or contraction of the light regulating sheet, the resin sheet is apt to be expanded or contracted, thus the tension stress can be transferred as stress to the pressure-sensitive adhesion layer in contact with the surface luminous element, so that the stress in the pulling direction generated in the pressure-sensitive adhesion layer in contact with the light regulating sheet is moderated, resulting in the light regulating sheet being hardly separated. Therefore, the thickness of the resin sheet is preferably 16 μm or less and further preferably 10 μm or less.

In the surface luminous body relating to the present invention, the total thickness of the pressure-sensitive adhesion layer in contact the surface luminous element, as long as the adhesive strength between the resin layer and the light outgoing surface of the surface luminous element is sufficient, is preferably thin, for example, 30 μm or less from the recent request of realization of a thin surface luminous body and more preferably 15 μm or less. The pressure-sensitive adhesion layer is composed of one or more kinds of pressure-sensitive adhesives and is preferably composed of two or more kinds of pressure-sensitive adhesives.

Hereinafter, the surface luminous body relating to the embodiments of the present invention will be described concretely with reference to the accompanying drawings. Further, the surface luminous body relating to the present invention is not limited to the embodiments indicated below and may be modified and executed appropriately without departing from the scope of the invention.

Hereinafter, the light regulating sheet relating to the present invention is referred to as a prism array sheet which is one form thereof.

### Embodiment 1

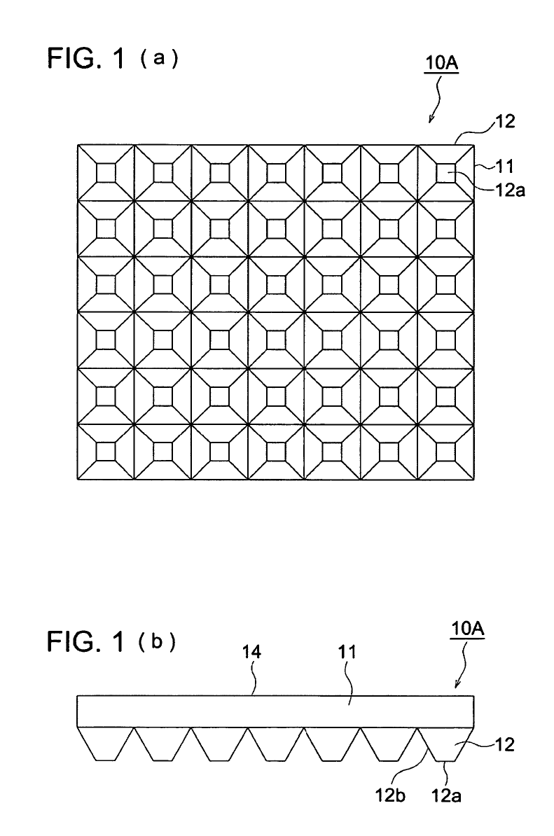

In Embodiment 1, as a light regulating sheet, as shown in FIGS. 1(a) and (b), a prism array sheet 10A composed of protrusions 12 in the truncated quadrangular pyramid shape having a contracted end side which are continuously formed lengthwise and crosswise on one side of a light transmissive substrate 11 is used. Further, in this specification, contraction of the end side of the protrusions 12 means that the protrusions 12 become gradually smaller as they go away from the prism array sheet 10A and in the examples shown in FIG. 1(b) and FIGS. 2 to 10 which will be described later, is tapered off.

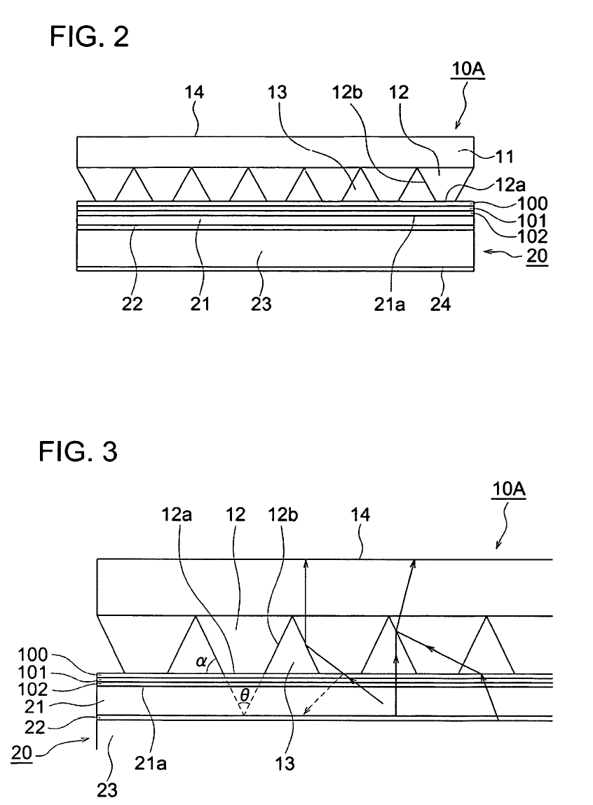

And, in the surface luminous body of Embodiment 1, as shown in FIG. 2, a surface luminous element 20 composed of an organic EL element in which on the surface of a transparent substrate 21 having an installed transparent electrode 22, an organic EL layer 23 and an opposite electrode 24 are installed is used. Onto a light outgoing surface 21a of the transparent substrate 21 from which light emitted from the surface luminous element 20 outgoes, end faces 12a of the protrusions 12 in the truncated quadrangular pyramid shape of the prism array sheet 10A are adhered with the adhesion layer composed of the first pressure-sensitive adhesion layer 100, a resin sheet 101, and the second pressure-sensitive adhesion layer 102.

As mentioned above, when onto the light outgoing surface 21a of the surface luminous element 20, the end faces 12a of the protrusions 12 in the truncated quadrangular pyramid shape of the prism array sheet 10A are adhered with the adhesion layer composed of the first pressure-sensitive adhesion layer 100, resin sheet 101, and second pressure-sensitive adhesion layer 102, the protrusions 12 of the prism array sheet 10A are contracted toward the light outgoing surface 21a of the surface luminous element 20 and space portions 13 between the protrusions 12 of the prism array sheet 10A and the light outgoing surface 21a of the surface luminous element 20 form an air layer.

As mentioned above, when onto the light outgoing surface 21a of the surface luminous element 20, the end faces 12a of the protrusions 12 in the truncated quadrangular pyramid shape of the prism array sheet 10A are adhered and the surface luminous element 20 emits light, the light is reflected totally on the light outgoing surface 21a of the surface luminous element 20 when the light regulating sheet is not installed. However, as shown in FIG. 3, on the portion where the end faces 12a of the protrusions 12 of the prism array sheet 10A are adhered, the light is not reflected totally but is led into the prism array sheet 10A.

The light led into the prism array sheet 10A in this way is mostly reflected on inclined surfaces 12b of the protrusions 12 which are interfaces between the protrusions 12 contracted toward the light outgoing surface 21a of the surface luminous element 20 and the space portions 13, and the reflected light is led to a light outgoing surface 14 of the prism array sheet 10A and outgoes. Further, as shown in FIG. 3, light outgoing from the portion of the light outgoing surface 21a where the end faces 12a of the protrusions 12 of the prism array sheet 10A are not adhered, if it outgoes vertically from the light outgoing surface 21a, although the traveling direction is changed slightly on the inclined surfaces 12b of the protrusions 12, outgoes on the front side of the prism array sheet 10A. Light outgoing in the perpendicular direction substantially to the inclined surface 12b of each of the protrusions 12 of the prism array sheet 10A from the light outgoing surface 21a is led from the inclined surface 12b into the protrusion 12, is reflected on the inclined surface 12b on the opposite side of the protrusion 12, and outgoes on the front side of the prism array sheet 10A.

Here, to lead appropriately light which is reflected totally on the light outgoing surface 21a of the surface luminous element 20 when the light regulating sheet is not installed as mentioned above, from the end faces 12a of the protrusions 12 relating to the surface luminous body of the present invention into the prism array sheet 10A, it is preferable to control the difference between the refractive index of the prism array sheet 10A and the refractive index of the light outgoing surface 21a of the surface luminous element 20 to be 0.2 or less.

Further, when installing the protrusions 12 in the truncated quadrangular pyramid shape on the prism array sheet 10A, if the apex angle θ at which the inclined surfaces 12b of the protrusions 12 intersect mutually is increased, and an inclination angle α of the inclined surfaces 12b of the protrusions 12 with the light outgoing surface 21a of the surface luminous element 20 is reduced extremely, even if light which is reflected totally on the light outgoing surface 21a of the surface luminous element 20 when the light regulating sheet is not installed is led into the prism array sheet 10A, the light does not hit on the inclined surfaces 12b of the protrusions 12 but is led to the light outgoing surface 14 of the prism array sheet 10A, is reflected totally on the light outgoing surface 14 of the prism array sheet 10A, and is returned. Thus the intensity of the light outgoing from the light outgoing surface 14 of the prism array sheet 10A is lowered.

On the other hand, when the apex angle θ at which the inclined surfaces 12b of the protrusions 12 intersect mutually is decreased, and the inclination angle α of the inclined surfaces 12b of the protrusions 12 with the light outgoing surface 21a of the surface luminous element 20 is increased extremely, the light led into the prism array sheet 10A as mentioned above is not reflected on the inclined surfaces 12b of the protrusions 12, is led to the space portions 13 through the protrusions 12, and is furthermore led again into the prism array sheet 10A through the space portions 13. The light is reflected totally on the light outgoing surface 14 of the prism array sheet 10A, and is returned. Thus the intensity of the light outgoing from the light outgoing surface 14 of the prism array sheet 10A is lowered.

Therefore, the apex angle θ at which the inclined surfaces 12b of the protrusions 12 intersect mutually, assuming the refractive index of the prism array sheet 10A for light with a wave length of 550 nm as “n”, meets preferably the condition (1/n−0.35)<sin θ<(1/n+0.3) and meets more preferably the condition 1/n<sin θ<(1/n+0.25).

Further, the range of an optical height “h” (shown in FIG. 5) of the protrusions 12 varies with the apex angle θ of the protrusions 12 and the pitch p of the protrusions 12. However generally, when the optical height “h” of the protrusions 12 is low extremely, on the light outgoing surface 21a of the surface luminous element 20, even if light reflected totally when the light regulating sheet is not installed is led into the prism array sheet 10A, the light does not hit on the inclined surfaces 12b of the protrusions 12 but is led to the light outgoing surface 14 of the prism array sheet 10A. The light is reflected totally on the light outgoing surface 14 of the prism array sheet 10A, and is returned. On the other hand, when the optical height h of the protrusions 12 is high extremely, in the inclined surfaces 12b of the protrusions 12, a part not used for reflection of light is generated. Further, when the pitch p of the protrusions 12 is the same, the area of the ends 12a of the protrusions 12 adhered to the light outgoing surface 21a of the surface luminous element 20 is reduced. Thus the quantity of light led into the prism array sheet 10A is reduced. Therefore, the optical height h of the protrusions 12 meets preferably the condition 0.28 p≦h≦1.1 p in relation to the pitch p of the protrusions 12.

The portion of the prism array sheet 10A of Embodiment 1 adhered with the light outgoing surface of the surface luminous element 20 will be described in detail.

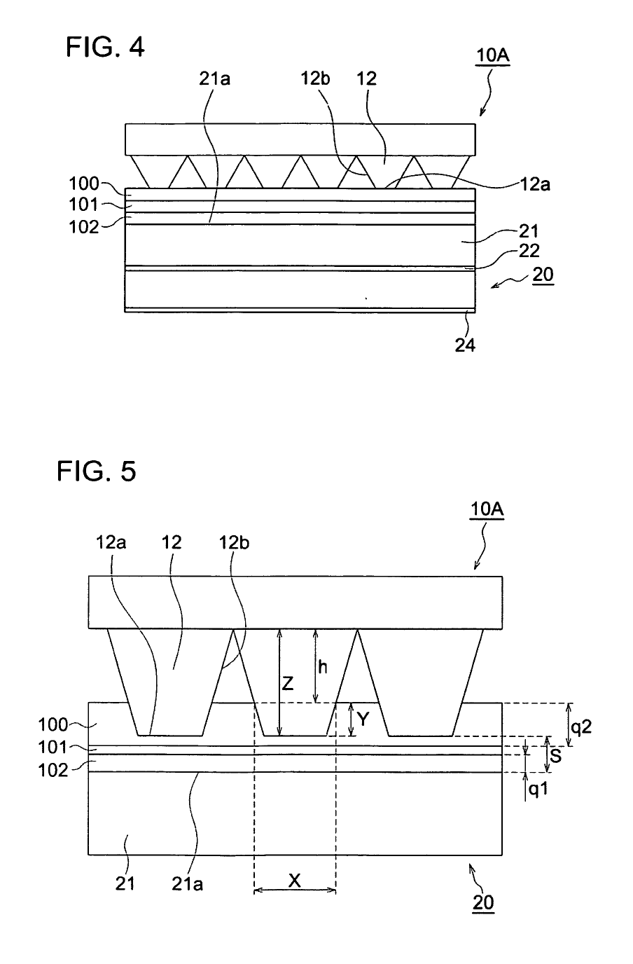

As shown in FIG. 4, on the light outgoing surface 21a of the surface luminous element 20, the adhesion layer composed of the transparent pressure-sensitive adhesion layer 102, transparent resin sheet 101, and transparent pressure-sensitive adhesion layer 100 and the prism array sheet 10A are laminated in this order and the ends 12a of the protrusions 12 of the prism array sheet 10A, pressure-sensitive adhesion layer 100, pressure-sensitive adhesion layer 102, and light outgoing surface 21a of the surface luminous element 20 are structured so as to be adhered optically closely.

As shown in FIG. 5, the neighborhood of the end faces 12a of the protrusions 12 of the prism array sheet 10A is formed so as to be embedded in the adhesion layer composed of the pressure-sensitive adhesion layer 100, resin sheet 101, and pressure-sensitive adhesion layer 102. The adhesion layer composed of the pressure-sensitive adhesion layer 100, resin sheet 101, and pressure-sensitive adhesion layer 102 and the protrusions 12 of the prism sheet are selected so as to have almost the same refractive index, so that the width of the prism array sheet 10A where it is adhered optically closely with the light outgoing surface 21a of the surface luminous element is the width equivalent to X shown in FIG. 5. Further, with respect to the height of the protrusions 12, the value obtained by subtracting the embedding depth Y shown in FIG. 5 from the height Z of the protrusions of the prism array sheet 10A is equivalent to the optical height h of the protrusions of the prism array sheet 10A. A ratio Y/Z of the embedding depth Y and the height Z of the protrusions of the prism array sheet 10A is preferably 0.1 to 0.5 and more preferably 0.15 to 0.4.

Further, assuming the total thickness of the pressure-sensitive adhesion layer as Q, using a thickness q2 of the pressure-sensitive adhesion layer 100 in contact with the prism sheet and a thickness q1 of the pressure-sensitive adhesion layer 102 in contact with the surface luminous element, Q=q1+q2 is held. The thickness of the pressure-sensitive adhesion layer between the ends of the protrusions of the prism sheet and the surface luminous element is expressed by a value resulting from subtracting the thickness of resin sheet 101 from S in FIG. 5 and in the present invention, the average thickness of the pressure-sensitive adhesion layer between the ends of the protrusions of the prism sheet and the light outgoing surface of the surface luminous element is less than 50% of the total thickness Q of the pressure-sensitive adhesion layer, preferably less than 35%, and more preferably less than 25%. Further, in FIG. 5, the end faces 12a of the protrusions 12 of the prism array sheet 10A exist in the pressure-sensitive adhesion layer 100 and it holds Y<q2, however, the end faces 12a may come in contact with the resin sheet 101, or may be embedded into the pressure-sensitive adhesion layer 102 via the pressure-sensitive adhesion layer 100 and the resin sheet 101. That is to say, Y≧q2 may be held.

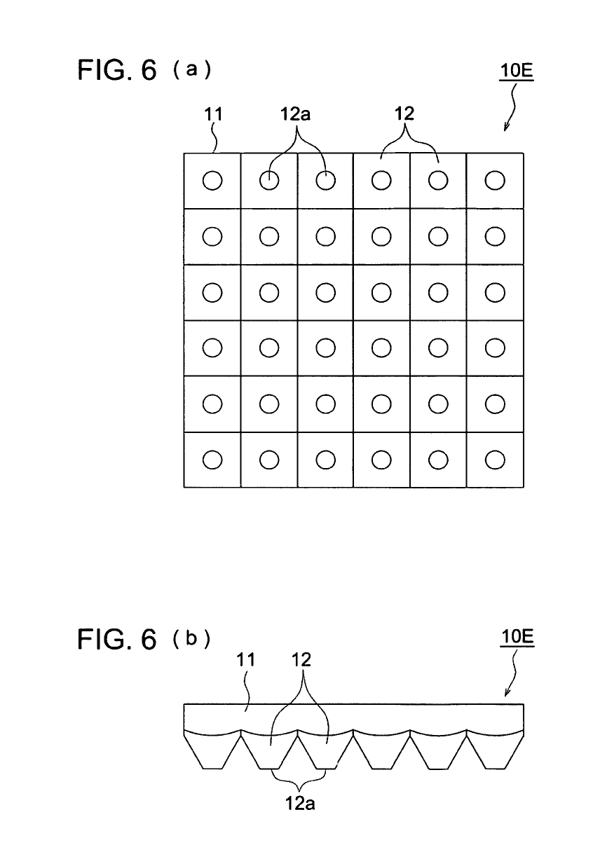

In the above description, as a shape of the prism array sheet 10A, the truncated quadrangular pyramid show in FIG. 1 is used as an example, however as a light regulating sheet, as shown in FIGS. 6(a) and 6(b), a prism array sheet 10E in which the peripheral part of the protrusions 12 in the truncated cone shape having the contracted end side is cut off and the resultant square protrusions are continuously formed lengthwise and crosswise on one side of the light transmissive substrate 11 may be used.

Here, when the protrusions 12 in the truncated cone shape are installed on the prism array sheet 10E, the front brightness of light outgoing through the prism array sheet 10E is more improved. According to the examination of the inventors, the reason may be considered that for example, when the protrusions 12 are in the truncated quadrangular pyramid shape as shown in FIG. 1, the apex angle formed by the ridgelines on the section in the direction of the ridgelines is smaller than the apex angle on the section in the arrangement direction of the protrusions 12 in the truncated quadrangular pyramid shape, so that outgoing light which cannot contribute sufficiently to improvement of the front brightness is generated. On the other hand, when the protrusions 12 are in the truncated cone shape, the vertical angle is fixed on the section in every direction, so that the outgoing light, which is generated in the case of the protrusions 12 in the quadrangular pyramid shape, and cannot contribute sufficiently to improvement of the front brightness is not generated.

### Embodiment 2

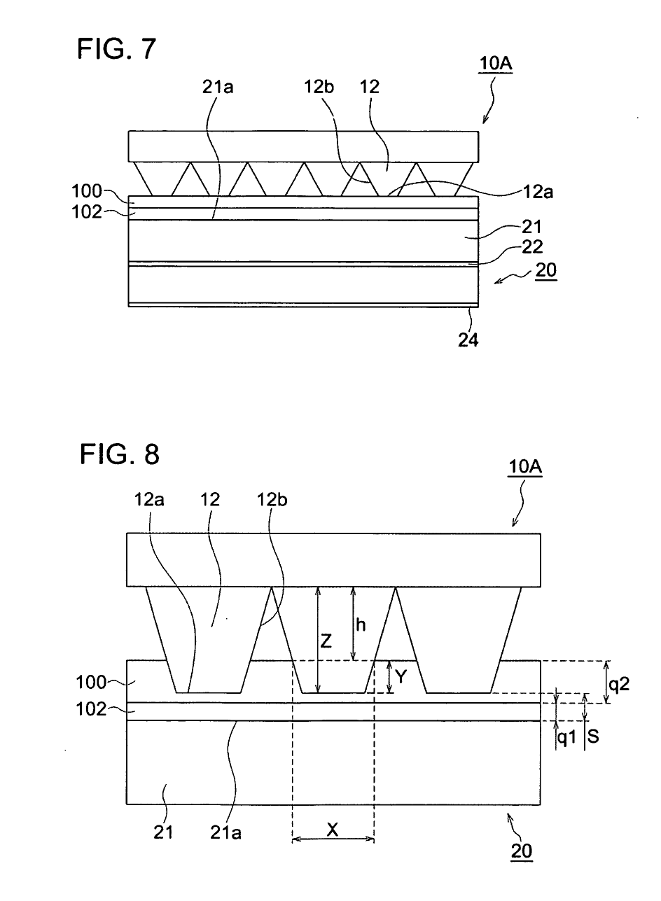

In Embodiment 2, as shown in FIG. 7, on the light outgoing surface 21a of the surface luminous element 20, the adhesion layer composed of the transparent pressure-sensitive adhesion layer 102 and transparent pressure-sensitive adhesion layer 100 and the prism array sheet 10A are laminated in this order and the end faces 12a of the protrusions 12 of the prism array sheet 10A, pressure-sensitive adhesion layer 100, pressure-sensitive adhesion layer 102, and light outgoing surface 21a of the surface luminous element 20 are structured so as to be adhered optically closely. To be more specific, as shown in FIG. 8, the neighborhood of the end faces 12a of the protrusions 12 of the prism array sheet 10A is formed so as to be embedded in the adhesion layer composed of the pressure-sensitive adhesion layer 100 and pressure-sensitive adhesion layer 102. The adhesion layer composed of the pressure-sensitive adhesion layer 100 and pressure-sensitive adhesion layer 102 and the protrusions 12 of the prism sheet are selected so as to have almost the same refractive index, so that the width of the prism array sheet 10A where it is adhered optically closely with the light outgoing surface 21a of the surface luminous element 20 is the width equivalent to X shown in FIG. 8. Further, with respect to the height of the protrusions 12, the value obtained by subtracting the embedding depth Y shown in FIG. 8 from the height Z of the protrusions of the prism array sheet 10A is equivalent to the optical height h of the protrusions of the prism array sheet. A ratio Y/Z of the embedding depth Y and the height Z of the protrusions of the prism array sheet 10A is preferably 0.1 to 0.5 and more preferably 0.15 to 0.4. Further, assuming the total thickness of the pressure-sensitive adhesion layer as Q, using a thickness q2 of the pressure-sensitive adhesion layer 100 in contact with the prism sheet and a thickness q1 of the pressure-sensitive adhesion layer 102 in contact with the surface luminous element, Q=q1+q2 is held. The thickness of the pressure-sensitive adhesion layer between the ends of the protrusions of the prism sheet and the light outgoing surface of the surface luminous element is expressed by S in FIG. 8 and in the present invention, the average thickness of the pressure-sensitive adhesion layer between the ends of the protrusions of the prism sheet and the light outgoing surface of the surface luminous element is less than 50% of the total thickness Q of the pressure-sensitive adhesion layer, preferably less than 35%, and more preferably less than 25%. Further, according to the present invention, the end faces 12a of the protrusions 12 of the prism array sheet 10A may be embedded into the pressure-sensitive adhesion layer 102. That is to say, S<q1 may be held.

### Embodiment 3

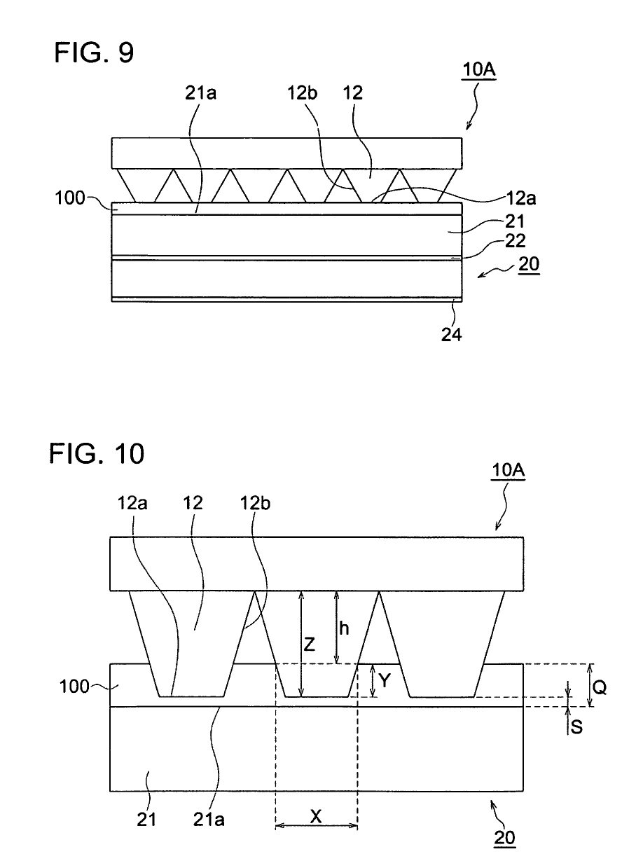

In Embodiment 3, as shown in FIG. 9, on the light outgoing surface 21a of the surface luminous element 20, the adhesion layer composed of the transparent pressure-sensitive adhesion layer 100 and the prism array sheet 10A are laminated in this order and the end faces 12a of the protrusions 12 of the prism array sheet 10A, pressure-sensitive adhesion layer 100, and light outgoing surface 21a of the surface luminous element 20 are structured so as to be adhered optically closely. To be more specific, as shown in FIG. 10, the neighborhood of the end faces 12a of the protrusions 12 of the prism array sheet 10A is formed so as to be embedded in the adhesion layer composed of the pressure-sensitive adhesion layer 100. The adhesion layer composed of the pressure-sensitive adhesion layer 100 and the protrusions 12 of the prism sheet are selected so as to have almost the same refractive index, so that the width of the prism array sheet 10A where it is adhered optically closely with the light outgoing surface 21a of the surface luminous element 20 is the width equivalent to X shown in FIG. 10. Further, with respect to the height of the protrusions 12, the value obtained by subtracting the embedding depth Y shown in FIG. 10 from the height Z of the protrusions of the prism array sheet 10A is equivalent to the optical height h of the protrusions of the prism array sheet. A ratio Y/Z of the embedding depth Y and the height Z of the protrusions of the prism array sheet 10A is preferably 0.1 to 0.5 and more preferably 0.15 to 0.4. In FIG. 10, the thickness of the pressure-sensitive adhesion layer between the ends of the protrusions of the prism sheet and the light outgoing surface of the surface luminous element and the thickness of the pressure-sensitive adhesion layer are expressed respectively by S and Q. In the present invention, the average thickness of the pressure-sensitive adhesion layer between the ends of the protrusions of the prism sheet and the light outgoing surface of the surface luminous element is less than 50% of the thickness Q of the pressure-sensitive adhesion layer, preferably less than 35%, and more preferably less than 25%.

By the surface luminous bodies of Embodiments 1 to 3 aforementioned, a surface luminous body having a high light take-out efficiency and high front brightness can be obtained.

Further, in the surface luminous bodies of Embodiments 1 to 3 aforementioned, the cases that the shape of the protrusions 12 of the prism array sheet is a truncated quadrangular pyramid and a truncated cone are described, however, as a shape for enhancing the light take-out efficiency and front brightness, the present invention is not limited to them and a truncated triangular pyramid and a truncated hexagonal pyramid are acceptable.

Further, in the surface luminous body of the embodiment aforementioned, as the surface luminous element 20, the organic EL element is used. However, the surface luminous element 20, if it emits light in a plane shape, is acceptable, thus an inorganic EL element or the like can be used, however use of an organic EL element expected to realize further great improvement of the brightness is effective particularly.

The surface luminous body of the present invention can be applied to various display devices as backlight, however it is preferably used as backlight of a liquid crystal display device having each LCD of various drive methods such as a reflection type, a transmission type, or a semi-transmission type LCD or a TN type, an STN type, an OCB type, an HAN type, a VA type (PVA type, MVA type), or an IPS type. Particularly, in a display device with a screen of 30 type or higher, particularly with a large screen of 30 type to 54 type, there is an effect of obtaining an image of high front brightness and a high contrast.

Applications of a multicolored or white organic electroluminescent (EL) element in the surface luminous body of the present invention will be described in further detail as preferred embodiments.

### (Display)

A display device that applies the luminous body involved in the present invention is described below.

The luminous body involved in the present invention is used in a multicolored or white display device. For the multicolored or white display device, only during formation of a luminous layer, a shadow mask is used and the film can be formed on one face by using a vapor deposition method, a casting method, a spin-coating method, an ink jet method, a printing method, or the like. When only the luminous layer is to be patterned, although the method used thereof is not limited, vapor deposition, an ink jet method, or a printing method is preferably used. Patterning that uses a shadow mask is preferable for vapor deposition.

In addition, a fabrication sequence can be reversed to fabricate a cathode, an electron transport layer, a hole-blocking layer, a luminous layer unit (this unit may have at least the above three luminous layers, A, B, C, and include non-light-emissive intermediate layers between the luminous layers), a hole transport layer, and an anode, in that order. To apply a direct-current voltage to the thus-obtained multicolored or white display device, emission of light can be observed by applying a voltage of about 2-40 V with plus (+) polarity assigned to the anode, and minus (−) polarity to the cathode. Voltage application with inverse polarity causes no emission of light since no current flows. Application of an alternating-current (AC) voltage generates the emission of light, only when the anode is plus and the cathode is minus. The AC voltage applied can take any waveform.

### (Illumination Device)

An illumination device that applies the luminous body of the present invention is described below.

The organic EL element involved in the present invention may be used in the form of one kind of lamp such as an illumination lamp or exposure light source, or may be used as a projector of a type which projects images, or as a display device of a type which makes static images or dynamic images directly visible. Driving of the organic EL element when used as a display device for replaying dynamic images may employ either a simple matrix (passive matrix) system or an active matrix system.

When necessary, the white organic EL element used in the present invention may be patterned by metal masking, ink jet printing, or the like, during the formation of a film. When patterning is needed, only electrodes may be patterned, electrodes and a luminous layer may both be patterned, or all layers of the element may be patterned. There are no restrictions on use of a luminous dopant for the luminous layer. For example, for a backlight in a liquid-crystal display element, a white color can be formed by selectively combining either any platinum complexes pertaining to the invention, or known luminous dopants, to ensure that the light obtained will fit a wavelength range appropriate for particular color-filter (CF) characteristics. Alternatively, the white color can likewise be formed by combination with a light-extracting and/or light-condensing sheet pertaining to the invention.

In this way, if the white organic EL element involved in the present invention is combined with a color filter (CF) and the element and a driving transistor circuit are disposed appropriately according to a particular pattern of the color filter (CF), the white light taken out from the organic EL element can be used as backlight to obtain blue light, green light, and red light via a blue filter, a green filter, and a red filter, respectively. This renders a longer-life full-color organic EL display device achievable at lower driving voltages, and is therefore preferable.

### (Industrial Field of Applications of the Organic EL Element and Luminous Body of the Present Invention)

The organic EL element involved in the present invention can be used as an indicating device, a display device, or various light sources. The kinds of light sources for the emission of light include, but not limited to, for example, the light sources intended to be used for illumination for a home, a car interior, backlight for a clock, a watch, or a crystal liquid, a commercial signboard advertisement, or a traffic signal machine, or for use as a light source in an optical memory medium, in an electrophotographic copying machine, in an optical communication processor, or in a photosensor. The organic EL element can be effectively used in applications as a backlight or illumination light source particularly in a display device formed by combining the above EL element with a color filter, an optical diffusing plate, a light-extracting film, or the like.

The organic EL element involved in the present invention can be applied to the following various illumination devices or luminous display bodies or the like by utilizing features of the element.

### (For Product Exhibition or Display)

Examples of application in product exhibition or display include merchandise or product display at shops, frozen or refrigerated food showcases, lighting up the exhibits at a museum, an exhibition site, vending machines, game-playing machines, traffic advertising, and so on.

Merchandise or product display at shops includes the decorative display or showcases of the shop itself, POP advertising, signs. In the commercial retailing field, especially, at high-grade brand shops, jewelry or other precious-metal shops, fashion-related shops, high-grade restaurants, and other shops attaching importance to the brand image of the shop, illumination affects the image of the shop very significantly and is therefore selected with strong persistence. In the field of indirect illumination where conventional architectural structures have been constructed with special care so as to create an atmosphere free of a directly visible light source, use of organic EL offers various advantageous effects in terms of the improvement of efficiency of workability. For example, installation space requirements for light source and equipment can be saved and hence, complex construction becomes unnecessary, or to create diffused light for interior, signs, and the like, it is possible to omit space requirements between the light source and a diffusing plate because the shape of the light source is invisible. In addition, the organic EL element has the features that it is a space-saving lightweight light source mountable in a display shelf, a floor, a fixture, a fitting, or the like, so utilizing these features makes it possible for the element to have the advantages of high design flexibility, excellent workability, and handy adoptability, as a tool for changing the image of the shop.

Frozen or refrigerated food showcases are placed at supermarkets, convenience stores, or the like, and illumination equipment is also one of the essential parts of these showcases so that illumination makes fresh vegetables, fruits, fish, dressed meat, and other perishables easier to view, look more fresh, and more readily hand-accessible, as commodities replete with “beauty” and “freshness”. The effects of organic EL light source usage upon a cooling function are insignificant because of low-temperature light emission, and the light source itself is small in thickness, so the space required for installation of the light source can be significantly reduced. This, in turn, renders a storage space extendable, provides a smart design, and makes food more easily selectable and more readily accessible. In addition, since the organic EL light source creates the colored light that makes the quality of the food readily recognizable, the quality can be appealed in natural form to consumers and this contributes to sales.

For lighting up the exhibits at a museum, an exhibition site, or the like, a light source suitable for its usage conditions needs to be selected in terms of, for example, the visibility of the exhibit and protection against a burn from the illumination. Color-fading preventive fluorescent lamps of a low UV ratio are therefore developed for these lighting applications. Since organic EL light sources create UV-free light and since the light created by these light sources is low in calorific value, the light sources do not adversely affect exhibits, form no glare because of uniform surface lighting, and are excellent in color rendering properties. These characteristics make it possible for visitors to appreciate the original figure of the exhibit faithfully. Additionally, since no large illumination devices are needed, visitors can focus attention only upon the exhibit, without seeing any unwelcome bulges of equipment in their fields of view. Furthermore, since organic EL light sources are characterized by their lightweight and thin construction, large electronic decorations that catch attention at large-scale exhibition sites such as a show are relatively easy to fabricate.

Vending machines use light sources in push-buttons, in commodity samples, and/or in the poster section of the machine front panel.

Advantages of the thin and space-saving organic EL light sources can be utilized in the field of vending machines since the space required for the incorporation of functions to be added, and the space required for storage of products are in a trade-off relationship with respect to the dimensions of the entire machine. Needs for these light sources are strong particularly at the poster space above the product takeout hole in the machine. In addition, machines not only intended for selling, but also endowed with a game-playing property such as providing the user with a chance to enjoy an additional product on a hit-or-miss basis have come into existence in recent years. Advantages of these vending machines can be further utilized by mounting a pixel-controlling light source (dynamic image display) in the poster section of the machine front panel.

Game-playing machines include pachinko (pinball game) machines and pachinko-slot machines. It is most important that these game-playing machines are able to make users feel and enjoy the amusement properties of the machine, such as a game-playing property and a gambling property. The small thickness of the light source is advantageous because the thickness of one machine can be correspondingly reduced. As with vending machines, however, game-playing machines can have the respective advantages further utilized by mounting a light source (dynamic image display) provided with a pixel control function.

Traffic advertisements include the poster and signboard advertisements provided in public space, the poster, signboard, and screen advertisements arranged in trains and buses, and the advertisements mounted on the bodies of these vehicles. In particular, posters and signboards of the box type backlighted by fluorescent lamps can have the box itself reduced in thickness and weight by changing these lamps to organic EL light sources.

For a suspended signboard, thinning down the box helps to minimize the accumulation of dust and dirt and to protect the surface from bird droppings.

### (Built-in Illumination for Upholstery, Furniture, and Building Materials)

In architecture and related fields, illumination integrated with a floor, a wall, a ceiling, or the like, is called “architectural illumination”. Typical examples of architectural illumination include cornice illumination, troffer illumination, cove illumination, luminous ceiling illumination, louver illumination, and so on, which are classified according to the scheme adopted for the illumination. These forms of illumination require that the illumination light source be built into the ceiling, wall, or floor of the building to delete the presence or hint of the illumination therefrom, and hence that the building material itself should give off light.

Light sources that use the organic EL element are best suited to “architectural illumination” in terms of thin, lightweight design, color-conditioning ability, and redesignability, and these light sources are applicable even to upholstery, furniture, fixtures, and fittings. The architectural illumination that has traditionally been used only in or at shops and art museums can be extended to general houses by developing such organic EL light sources to exploit a new demand.

In commercial facilities, an optimum commercial space not dependent upon weather or upon time of the day can be constructed by adopting organic EL light sources in the ceilings and other sections of semi-underground shops or arcades and changing the brightness or color temperature of the illumination.

Examples of applicable interior sections or articles, furniture, fixtures, and fittings include, but not limited to, desks, tables, chairs, sofas, cupboards, shoeboxes, lockers, bathroom vanities, family altars, bed lights, footlights, handrails, doors, sliding doors, etc.

Meantime, selective use of transparent or opaque condition is also possible by using an organic EL light source with transparent electrodes and activating or deactivating the light source. This, in turn, also makes the light source usable as a door, a curtain, a blind, or a partition.

### (Automotive Illumination or Luminous Indicators and Displays)

Organic EL elements can be used in automotive applications as exterior illumination devices or luminous indicators and displays, and as interior illumination devices or luminous indicators and displays. The former applicable sections include automobile front sections such as headlamps, auxiliary lamps, side marker lamps, fog lamps, and direction indicator lamps, and rear sections such as a rear combination lamp assembly formed up of stop lamps, rear side marker lamps, reversing lights, direction indicator lamps, a license plate lamp. In particular, forming a rear combination lamp assembly with one organic EL element and attaching it to the rear of the vehicle reduces a rear-lamp installation space for a wider trunk room. When clear vision is unobtainable because of rain or fog, visibility can be enhanced by increasing the side marker lamps or the stop lamps in area. Also, visibility from a lateral direction can be raised by emitting light on tire wheels with the organic EL element. Additionally, new conception can be incorporated into a body color and/or design of the vehicle by forming the entire body with the organic EL element and activating it.

The automobile interior illumination devices or luminous indicators and displays applicable to automobile sections of the latter case include passenger compartment lamps, map lights, doorstep lights, instruments and gauges, car navigation displays, warning lights, and so on. In particular, utilizing transparency of the organic EL element also makes it possible to use the EL element, as a sunroof in the daytime, and as a passenger compartment lamp at night that emits mild light as a surface light source when activated. In addition, for use in a taxi or the like, if an illumination device including the organic EL element is attached to a back face of a front seat, a handy illumination system can be constructed that does not inconvenience the driver during driving, and that a user can easily use without sacrificing an interior space.

### (Public Transportation)

Features of the organic EL element of the present invention can be utilized particularly in the vehicle interior illumination and indicators/displays provided in public transportation such as trains, subways, buses, airplanes, and ships.

Various illumination devices are mounted in and on airplanes, and passenger compartment illumination, cargo compartment illumination, cockpit illumination, and the like are mounted in the fuselage. Of these diverse forms of illumination, passenger compartment indirect illumination, in particular, is where organic EL illumination can have its advantages fully utilized.

Passenger compartment illumination uses fluorescent lamps and electric bulbs, which are used to form lateral reflecting indirect illumination of the ceiling. In addition, these light sources are constructed so as to provide a relaxed atmosphere to the passenger compartment and so as to prevent any broken pieces of glass from falling onto the passenger's seat even in case of damage due to trouble.

The small thickness of the organic EL element makes it easy to create indirect illumination. In addition, even for direct illumination, the EL element causes no danger of any broken pieces flying about and can create a relaxed atmosphere with diffused light.

Additionally, since reduction in electric power consumption and reduction in fuselage weight are essential to airplanes, the organic EL element is preferable that is lightweight and small in electric power consumption. Not only these advantages help to illuminate the passengers, but also can the advantages be displaced in illuminating the inside of a hand luggage storage space, and these make the light source contributive to reducing the amount of luggage which may be left inside.

The display and illumination intended to guide the passengers can also be used at stations, bus stops, airports, or other facilities annexed to public transportation. At night and outdoors, the organic EL light source can be used for people who are waiting at bus stops (and the like) for buses and detected by illuminating these people more brightly, thus contributing to crime control and prevention.

### (Light Source for OA Machines)

The OA machines to which the organic EL light source can be applied include, for example, the facsimile machines, copying machines, scanners, printers, and complex machines thereof, that have a mounted sensor(s) for reading.

Sensors for reading are divided into a contact image sensor (CIS) type that is combined with equi-magnification optics, and a reduction sensor (CCD linear sensor) type that is combined with reduction optics.

The definition of CIS varies from manufacturer to manufacturer. A sensor rod lens array LED substrate of a moduled version may be called CIS, or a moduled structure may be called a contact image sensor module (CISM), or a moduled sensor chip may be called CIS. These light sources are LEDs, xenon lamps, CCFL lamps, LDs or the like.

Further size reduction and lower-voltage driving of OA machines are being demanded, and the organic EL element that features small thickness and drivability with a minimum amount of heat and at low voltage can meet those demands.

### (Industrial Inspection Systems)

Formerly, manufacturing companies have needed to use a large number of man-hours and a large deal of man-power during visual inspection of products or components. Recently, however, optical imaging has been employed to implement judgment of defectives for automated inspection. During the automated inspection that uses such imaging, CCD camera images of objects to be inspected are converted into digital signal form and the digital signal is next subjected to various arithmetic processing, whereby features of the objects, such as an area, length, quantity, and position, are then extracted and judgment results based on predetermined criteria are output. Such optical imaging requires light sources. Such an inspection system is also used during a package inspection, a shape/size inspection, a micro-component inspection, and the like.

Illumination light sources for image sensors include fluorescent lamps, LEDs, halogen lamps. Above all, backlights for illuminating a transparent container, a lead frame, or the like, are required to form planarly uniform light.

In addition, linearly uniform light for illuminating a widthwise total face of a sheet is required for detection of dirt on the sheet. For these reasons, requirements of a light source to be used differ according to the type and/or specifications of article inspected.

Adopting an organic EL light source in this field also makes it possible, for example, to arrange illumination in all 360-degree directions around a bottle in a bottling process and optically image the bottle by illuminating it from all directions at the same time. Article inspection within a minimum time also becomes possible. Additionally, the space taken up by the light source itself in the inspection system can be reduced significantly. Furthermore, since the organic EL light source is a surface light source, it is possible to avoid erroneous detection due to reflected light likely to make optically acquired images difficult to evaluate in quality.

### (Light Sources for Agricultural Cultivation)

Plant factories are “year-round production systems that use advanced technology such as environmental control and/or automation.” The production is a technique intended to produce crops automatically without human intervention and independently of weather, by controlling the plant cultivation environmentally with a computer. In consideration of further increases in the world's population and of global environmental problems, introducing high-technology into agriculture requires so-called the industrialization of agriculture that leads to more stable production of foodstuffs. Recently, LEDs and/or LDs have become more likely to be used as light sources for plant cultivation. The high-pressure sodium lamps and other light sources that have been frequently used for long periods of time are disadvantageous in that these light sources tend to oversize facilities. This is because the light sources are unbalanced in spectrum between red light and blue light, and the sources cause significant heat radiation leading to increased air-conditioning loads, and need to be sufficiently distanced from plants.

Organic EL light sources are thin, enable a number of shelves to be set up, and are small in thermal calories, so arranging each light source in close proximity to plants enhances illumination efficiency and increases a cultivation volume.

For application to a general house, utilizing the advantage of space saving of it makes it possible to create a vegetation or flower garden in a confined indoor space such as a kitchen, and to change the concept of vegetation or flower gardening which has formerly been possible only in an outdoor space such as a garden, balcony, or roof. These features of organic EL illumination enable person to enjoy private gardening in a variety of ways.

### (Illumination for Escape)

The disaster-preventing illumination equipment provided for by the fire protection law or the building code includes guide lights pointing to exits and routes for an escape in the event of fire, and emergency lights intended to ensure the brightness of the escape route and secure a rapid escape.

The signal lights, guide lights, emergency lights, and other lighting devices used for factory automation (FA) or for civilians are absolutely required to be easy to view. At certain installation locations, however, dimensional enlarging of these illumination devices in an attempt to meet the requirement has occasionally caused a structural imbalance against the building, and this drawback has tended to be pointed out by the architect and/or designer for the building. The measures taken to compensate for this drawback are by adopting pictographic representation for immediate identification, or by enhancing a visual appealing effect with a light source. Traditionally, fluorescent lamps have primarily been used as the light sources intended for guidance. Recently, however, LED-based guide lights have also come into existence.

Using organic EL light sources in these guide lights makes it possible to avoid changes in brightness, to prevent decreases in brightness due to changes in angular characteristics, and to improve visibility. These light sources also render special work unnecessary because of low electric power consumption and small thickness, thus facilitating installation. In addition, compared with a conventional type that uses a fluorescent lamp, these light sources do not require frequent replacement and their maintenance are easy. Furthermore, discoloration of their light-emitting surfaces due to light is minimized since the amount of heat generated is small. The light sources can therefore be installed on the floor along escape routes, on handrails of stairways, on fire doors, and in many other places, thereby to enhance safety. Besides, the organic EL light sources do not pose the mercury-associated problems currently dealt with in association with fluorescent lamps, and are resistant to cracking and breaking, and excellent in safety. Moreover, space-saving thin design prevents deterioration in appearance and enhances a visual appealing effect.

### (Photographic Illumination)

Halogen lamps, tungsten lamps, stroboscopes, fluorescent lamps, and the like are used as light sources in photo studios, personal identification photoboxes, or the like. Light from these light sources is linearly and directly applied to a target, thereby to provide strong shading or create diffused light. Two major kinds of light, inclusive of soft light substantially free of shading, are thus created and the two kinds of light are combined from various angles to form one picture. Light can be diffused using a method such as inserting a diffuser between the light source and the target or using reflected light coming from the surface of a reflector or any other surface (reflection plate).

Organic EL light sources form diffused light, and this light can be sent forth without using a diffuser. These light sources have various advantages. These include the advantage that the space between the light source and diffuser required for an existing light source can be dispensed with, and the advantage that conditioning a subtle shading level by adjusting a direction of light at a subtle angle with a reflector or the like can be implemented by bending the flexible type of organic EL element itself.

Light sources for photographing may be required to have a color-rendering property. If the way the color is expressed differs significantly with respect to the way the color looks when exposed to solar rays, the light source is considered to be inferior in color-rendering property, and if the difference is not significant, the light source is considered to be excellent in color-rendering property. Because of their wavelength characteristics, the fluorescent lamps used at general homes are not preferable for photographing, and a section exposed to the light formed by such a lamp tends to be greenish. Colors of the skin, facial make-up, hair, clothing, jewelry, and the like, are usually required to be photographed in the color of the object itself, so the color-rendering property is one of essential factors for the light. Organic EL light sources are excellent in color-rendering property, and are therefore preferable for photographing what requires such faithfulness of color as described above. The excellent color-rendering property can likewise be utilized at printing, dyeing, and other related places in which the color is to be faithfully evaluated.

If such surface light sources as organic EL light sources are arranged over an entire ceiling surface of a studio, natural facial expressions of children and pets can be photographed in natural colors, without troublesome movement of the light sources, while the children and the pets are allowed to freely play indoors.

### (Electrical Household Appliances)

In order to allow for ease in visual access to details, for ease in working, and for design, electrical household appliances usually come with a light source. By way of example, sewing machines, microwave ovens, dish cleaners-desiccators, refrigerators, and audio-visual (AV) devices traditionally include a light source. Recent horizontal models of wash-drying machines for clothes also have a light source because of the increased number of cases in which the clothes are left inside after use of the horizontal models. Existing products usually have an incandescent bulb and/or an LED. In the future, illumination will be provided at a distal end of a vacuum cleaner so that a cleaning status of a shady section of furniture or the like can be confirmed, or a shaver will have a light source of a specific wavelength so that a shaving status can be confirmed, or light sources will be used in various other forms in a variety of appliances.

It is demanded that these electrical household appliances is totally reduced in weight and dimensions and have a larger storage space, so it is demanded that light source sections should each be as less spacious as possible and totally illuminate. The thin organic EL surface light sources can sufficiently meet these demands.

### (Play or Amusement Facilities)

An atmosphere of light different from that of overhead spotlights can be expressed by disposing organic EL light illumination under the ice of a skate link. Organic EL is particularly advantageous for its low light-emitting temperature. In addition, by detecting positions of skaters, light of organic EL can be emitted synchronously with movements of the skaters. Furthermore, providing advantageous effects such as combination with spotlights and/or light emission synchronized with a musical rhythm is effective for livening up the sport event.

In a planetarium, arranging microstructured organic EL pixels in an entire dome, instead of employing conventional upward projection from below the dome, renders a projector-free planetarium realizable, since the dome itself can be made to look as if it were illuminating stars.

### (Illumination Lighting)

Formerly, illumination has usually referred to that of trees. In recent years, however, there is an increasing tendency for illumination to be shifted to decorating houses, gates, hedges, and other artificial structures, for environmental protection. This tendency is considered to be further spread by the advent of LEDs, since linear decorations with a number of spot light sources are prevailing.

Up until now, it has only been possible in this field to express lighting by connecting spot light sources. The use of organic EL illumination, however, makes it possible to form variations and further enhance an illumination effect. Examples are providing a tree with leaf-shaped illumination, and winding the light source around the tree and lighting up the entire tree, or conversely, connecting a plurality of light sources to form a definitely shaped surface module similar to a succession of spot light sources, and projecting a character or a picture by using the module as a cocktail palette which provides light of various colors.

### (Illumination of Personal Belongings or of Clothes)

The reflector products (reflecting sheets) that can be attached to personal belongings, shoes, or clothes, to protect the safety of pedestrians by reflecting headlight-emitted light are sold and used so that these reflectors can be readily recognized from automobiles, motorcycles, and the like, during outdoor night walking or physical exercises.

For a glass beads type, the presence of very small glass beads on the surface permits incident light to recursively reflect in a direction of the light source by serving as a lens, and when light from an automobile is cast upon the beads, it returns to a position of eyes of a driver to shine brilliantly. Although a prism type is the same as the glass beads type in function, differs in lens structure. The glass beads type and the prism type have the characteristics that the former has an excellent reflecting effect against oblique light, whereas the latter reflects more significantly against front light than the glass beads type, but a reflecting effect against oblique light is relatively weak. A desired material and attaching method can be selected according to particular hardness of an attaching location. It has traditionally been necessary for both types to be exposed to light to make a pedestrian wearing the reflector recognizable. For example, there has been a need to attach the reflector to a portion of a leg or foot so that the pedestrian can be recognized as soon as possible by being illuminated with the light emitted from a downward-directed headlight.

Greater safety can be ensured by using an organic EL light source as an alternative for the above light sources, since this makes it possible, before the EL light source is exposed to the light emitted from headlights, to make drivers recognize a pedestrian wearing the EL light source. In addition, partly since organic EL elements are lightweight, thin, and formable into a shape of a sheet, it is possible to obtain advantageous effects while at the same time maintaining advantages of the sheet. These can be applied to not only a person, but also clothes for pets, for example. Additionally, the organic EL that saves electric power makes it possible for a person to generate electricity by walking and illuminate clothes. Furthermore, organic EL is also applicable particularly to human identification clothes, and is useful, for example, for early protecting a person suffering from ambulatory automatism. Organic EL is further likely to be usable to locate a diver and protect the diver from sharks and the like, by illuminating a diving wetsuit. Naturally, application to a stage costume for a show, to a wedding dress, and to other kinds of clothes, is also possible.

### (Light Sources for Communications)

A light emitter that uses the organic EL element is also effectively usable as a “visible light tag” which uses visible light to send information such as a simple message. That is to say, it is possible, by emitting a very brief blinking optical signal, to send a large volume of information to a receiver of the signal.

Although the light emitter is emitting the optical signal, since the emission is conducted only for a very short time, a person visually recognizes the light as mere illumination. Illumination provided in different places such as a road, shop, exhibition site, hotel, or amusement park, makes it possible to transmit a characteristic information signal of each location and supply necessary information to a receiving person. For organic EL, it is also possible, by mounting a plurality of light-emitting dopants of different wavelengths in one light emitter and generating different signals at different wavelengths, to make the emitter supply different pieces or kinds of information. Organic EL stable in light-emitting wavelength and in color tone is predominant in such a case.

Unlike the supply of information that uses voice signals, radio waves, infrared rays, or the like, the “visible light tag” can be mounted together during installation of illumination equipment. Complex additional installation, therefore, is not required.

### (Medical Light Sources)

Adopting organic EL in an endoscope that currently uses a halogen lamp as a light source, or in illumination for the peritoneal surgery that involves wire insertion, contributes to reduction in size and weight and to expansion of applications. In particular, application to an encapsulated endoscope (pill typed endoscope) designed for in-vivo examination or for therapy is also possible and anticipated. Encapsulated endoscopy is a technique that has caught attention in recent years.

### (Others)

A light emitter that contains the organic EL element of the present invention makes easy selection of a color tone possible, and unlike a fluorescent lamp, the EL light emitter is free of blinking. Additionally, this light emitter saves electric power and is stable in color tone. For these reasons, organic EL light emitters are useful in the form of such an insect pest controller as disclosed in Unexamined Japanese Patent Application Publication No. 2001-269105, such a mirror illumination device as disclosed in Unexamined Japanese Patent Application Publication No. 2001-286373, such a bathroom illumination system as disclosed in Unexamined Japanese Patent Application Publication No. 2003-288995, such a plant-growth artificial light source as disclosed in Unexamined Japanese Patent Application Publication No. 2004-321074, such a water pollution measuring device as disclosed in Unexamined Japanese Patent Application Publication No. 2004-354232, such a therapeutic adherend using a light-sensitive medical agent, as disclosed in Unexamined Japanese Patent Application Publication No. 2004-358063, or such a shadowless lamp for medical treatment, as disclosed in Unexamined Japanese Patent Application Publication No. 2005-322602.

### EXAMPLE

The surface luminous body relating to the embodiments of the present invention and the surface luminous body of the comparative example are compared and it will be described below that in the surface luminous body relating to the examples of the present invention and the manufacturing method thereof, the take-out efficiency of light outgoing from the surface luminous body and the front brightness are improved greatly and even when it is preserved in an environment of high temperature and high humidity and furthermore, even when external pressure is applied, it has a stable adhesion state and the light take-out efficiency and front brightness are changed little. However, the present invention is not limited to it.

### Example 1

In Example 1, similarly to the surface luminous body of Embodiment 1 except use of the prism array sheet 10E in place of the prism array sheet 10A, the surface luminous body was formed by adhering the prism array sheet 10E to the surface luminous element 20 using the adhesion layer composed of the first pressure-sensitive adhesion layer, resin sheet, and second pressure-sensitive adhesion layer.

As the surface luminous element 20, as mentioned above, the surface luminous element 20 composed of the organic EL element in which the organic EL layer 23 and opposite electrode 24 were installed on the surface of the transparent substrate 21 having the installed transparent electrode 22 was used.

Here, in the surface luminous element 20, as the transparent substrate 21, non-alkali glass with dimensions of 0.7 mm (thickness)×40 mm (length)×52 mm (width) was used, and on one side of the transparent substrate 21, as the transparent electrode 22, ITO (indium oxide with tin doped) was coated on it as a film with a thickness of 150 nm, and it was patterned in an electrode shape by the photolithographic method, and the surface luminous element was structured so as to emit light from a surface whose size was 35×46 mm. Further, the resistance of the transparent electrode 22 measured using Loresta (manufactured by Mitsubishi Chemical Corporation) was 20 Ω/□.

Next, on the transparent electrode 22, as a hole injecting material, a hole injection layer with a film thickness of 20 nm was formed by the vacuum evaporation method by using m-MTDATA. Then, on the hole injection layer, as a hole transport material, a hole transport layer with a film thickness of 20 nm was formed by the vacuum evaporation method by using NPD. Then, on the hole transport layer, a luminous material for emitting green light was deposited by the vacuum evaporation method by using CBP as a host material so as to include Ir(ppy)₃ of 6% by mass as a dopant material, thus a luminous layer with a film thickness of 30 nm was formed. On the luminous layer, BAlq was deposited with a thickness of 10 nm by the vacuum evaporation method, thus a hole blocking layer was formed. Furthermore, on the hole blocking layer, Alq₃ was formed with a thickness of 40 nm as an electron transport layer by the vacuum evaporation method. Furthermore, LiF was formed with a thickness of 0.5 nm as an electron injection layer by the vacuum evaporation method. And, on the electron injection layer, the opposite electrode 24 composed of aluminum with a film thickness of 100 nm was formed by the sputtering method.

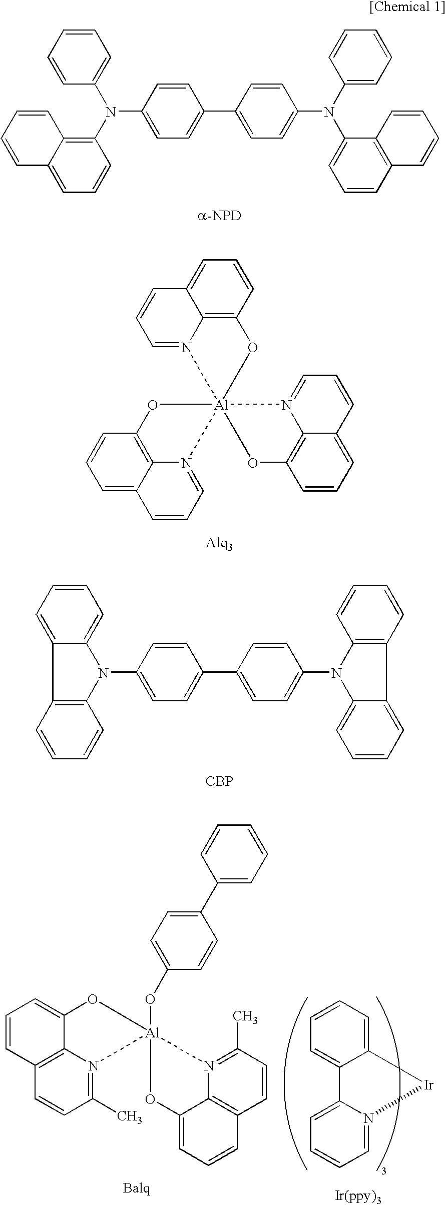

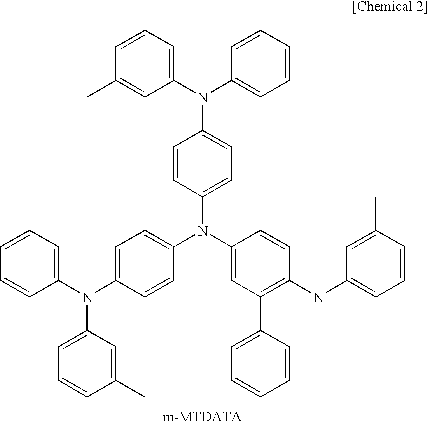

Further, the transparent substrate 21 on the side of the light outgoing surface 21a of the surface luminous element 20 had a refractive index of 1.517 for light with a wave length of 550 nm.

Next, using the prism array sheet 10E on which the conical protrusions 12 were formed continuously on one side of the light-transmissive substrate 11, similarly to the prism array sheet 10A shown in FIG. 2, the protrusions 12 in the truncated cone shape on the prism array sheet 10E were positioned to face the light outgoing surface 21a of the surface luminous element 20 and the prism array sheet 10E was adhered to the light outgoing surface 21a of the surface luminous element 20. For the pressure-sensitive adhesion layer in contact with the prism array sheet 10E, an acrylic pressure-sensitive adhesive with a thickness of 5 μm as the first pressure-sensitive adhesion layer 100, a PET sheet with a thickness of 6 μm as a resin sheet 101, and an acrylic pressure-sensitive adhesive with a thickness of 5 μm as the second pressure-sensitive adhesion layer 102 were used. Further, a ratio B/A of the prism embedding load A of the pressure-sensitive adhesive of the pressure-sensitive adhesion layer 102 in contact with the surface luminous element 20 used here and the prism embedding load B of the pressure-sensitive adhesive of the pressure-sensitive adhesion layer in contact with the prism array sheet 10E was 1. On the prism array sheet 10E, the protrusions in the truncated cone shape were formed with acrylic resin on the polycarbonate substrate with a thickness of 125 μm, and the apex angle θ of the protrusions 12 in the truncated cone shape was 50°, and the height of the protrusions 12 in the truncated cone shape was 26.6 μm, and the pitch of the protrusions 12 was 35 μm.

The embedding depth was measured immediately after the prism array sheet 10E was adhered to the light outgoing surface 21a of the surface luminous element and a mean value of 3 μm was obtained. The surface luminous body was heated at 85° C. for 15 hours and was returned to the room temperature, thus the surface luminous body relating to Example 1 was obtained. The embedding depth of the surface luminous body was measured and a mean value of 6 μm was obtained and the average thickness of the pressure-sensitive adhesion layer between the ends of the prism and the light outgoing surface of the surface luminous element was 40% of the total thickness of the pressure-sensitive adhesion layer. Assuming that the front brightness and light take-out efficiency of the surface luminous body were 1 when the prism array sheet 10E was not adhered, the front brightness of the surface luminous body of Example 1 was 2.0 and the light take-out efficiency was 1.50.

### Example 2

In Example 2, based on the preparation of the surface luminous element relating to Example 1, in the pressure-sensitive adhesion layer in contact with the prism array sheet 10E, an acrylic pressure-sensitive adhesive with a thickness of 4 μm as the first pressure-sensitive adhesion layer 100, a PET sheet with a thickness of 6 μm as the resin sheet 101, and an acrylic pressure-sensitive adhesive with a thickness of 5 μm as the second pressure-sensitive adhesion layer 102 were used. Further, the ratio B/A of the prism embedding load A of the pressure-sensitive adhesive of the pressure-sensitive adhesion layer 102 in contact with the surface luminous element 20 used here and the prism embedding load B of the pressure-sensitive adhesive of the pressure-sensitive adhesion layer in contact with the prism array sheet 10E was 0.6. The embedding depth was measured immediately after the prism array sheet 10E was adhered to the light outgoing surface 21a of the surface luminous element and a mean value of 4 μm was obtained. The surface luminous body was heated at 85° C. for 20 hours and was returned to the room temperature, thus the surface luminous body relating to Example 2 was obtained. The embedding depth of the surface luminous body was measured and a mean value of 6 μm was obtained and the average thickness of the pressure-sensitive adhesion layer between the ends of the prism and the light outgoing surface of the surface luminous element was 33% of the total thickness of the pressure-sensitive adhesion layer. Assuming that the front brightness and light take-out efficiency of the surface luminous body were 1 when the prism array sheet 10E was not adhered, the front brightness of the surface luminous body of Example 2 was 2.0 and the light take-out efficiency was 1.50.

### Example 3

In Example 3, based on the preparation of the surface luminous element relating to Example 1, in the pressure-sensitive adhesion layer in contact with the prism array sheet 10E, an acrylic pressure-sensitive adhesive with a thickness of 4 μm as the first pressure-sensitive adhesion layer 100, a PET sheet with a thickness of 2 μm as the resin sheet 101, and an acrylic pressure-sensitive adhesive with a thickness of 4 μm as the second pressure-sensitive adhesion layer 102 were used. Further, the ratio B/A of the prism embedding load A of the pressure-sensitive adhesive of the pressure-sensitive adhesion layer 102 in contact with the surface luminous element 20 used here and the prism embedding load B of the pressure-sensitive adhesive of the pressure-sensitive adhesion layer in contact with the prism array sheet 10E was 0.4. The embedding depth was measured immediately after the prism array sheet 10E was adhered to the light outgoing surface 21a of the surface luminous element 20 and a mean value of 4 μm was obtained. The surface luminous body was heated at 85° C. for 30 hours and was returned to the room temperature, thus the surface luminous body relating to Example 3 was obtained. The embedding depth of the surface luminous body was measured and a mean value of 6 μm was obtained and the average thickness of the pressure-sensitive adhesion layer between the ends of the prism and the light outgoing surface of the surface luminous element was 25% of the total thickness of the pressure-sensitive adhesion layer. Assuming that the front brightness and light take-out efficiency of the surface luminous body were 1 when the prism array sheet 10E was not adhered, the front brightness of the surface luminous body of Example 3 was 2.0 and the light take-out efficiency was 1.55.

### Example 4

In Example 4, similarly to the surface luminous body of Example 3, the prism array sheet 10A was adhered to the surface luminous element 20 using the adhesion layer composed of the pressure-sensitive adhesion layer 100. Further, the refractive index for light with a wave length of 550 of the prism array sheet 10A nm was 1.495, and the apex angle θ of the protrusions 12 in the truncated quadrangular pyramid shape was 500, and the height of the protrusions 12 in the truncated quadrangular pyramid shape was 32.9 μm, and the pitch of the protrusions 12 was 35 μm. Further, for the pressure-sensitive adhesion layer 100, an acrylic pressure-sensitive adhesive with a thickness of 10 μm was used. The embedding depth was measured immediately after the prism array sheet 10E was adhered to the light outgoing surface 21a of the surface luminous element 20 and a mean value of 3 μm was obtained. The surface luminous body was heated at 85° C. for 10 hours and was returned to the room temperature, thus the surface luminous body relating to Example 4 was obtained. The embedding depth of the surface luminous body was measured and a mean value of 6 μm was obtained and the average thickness of the pressure-sensitive adhesion layer between the ends of the prism and the light outgoing surface of the surface luminous element was 40% of the total thickness of the pressure-sensitive adhesion layer. Assuming that the front brightness and light take-out efficiency of the surface luminous body were 1 when the prism array sheet 10E was not adhered, the front brightness of the surface luminous body of Example 4 was 1.9 and the light take-out efficiency was 1.40.

### Example 5

In Example 5, similarly to the preparation of the surface luminous element relating to Example 4, except use of the prism array sheet 10E in place of the prism array sheet 10A, the surface luminous body was prepared. The embedding depth was measured immediately after the prism array sheet 10E was adhered to the light outgoing surface 21a of the surface luminous element 20 and a mean value of 3 μm was obtained. The surface luminous body was heated at 85° C. for 10 hours and was returned to the room temperature, thus the surface luminous body relating to Example 5 was obtained. The embedding depth of the surface luminous body was measured and a mean value of 6 μm was obtained and the average thickness of the pressure-sensitive adhesion layer between the ends of the prism and the light outgoing surface of the surface luminous element was 40% of the total thickness of the pressure-sensitive adhesion layer. Assuming that the front brightness and light take-out efficiency of the surface luminous body were 1 when the prism array sheet 10E was not adhered, the front brightness of the surface luminous body of Example 5 was 2.0 and the light take-out efficiency was 1.50.

### Comparative Example 1

In Comparative Example 1, in the preparation of the surface luminous element relating to Example 4, similarly except omission of heating after adhesion of the prism array sheet 10A, the surface luminous body of Comparative Example 1 was prepared. The embedding depth was measured immediately after the prism array sheet 10A was adhered to the light outgoing surface 21a of the surface luminous element 20 and a mean value of 3 μm was obtained and the average thickness of the pressure-sensitive adhesion layer between the ends of the prism and the light outgoing surface of the surface luminous element was 70% of the total thickness of the pressure-sensitive adhesion layer. Assuming that the front brightness and light take-out efficiency of the surface luminous body were 1 when the prism array sheet 10A was not adhered, the front brightness of the surface luminous body of Comparative Example 1 was 1.7 and the light take-out efficiency was 1.20.

### Comparative Example 2

In Comparative Example 2, similarly to the preparation of the surface luminous element relating to Comparative Example 1, except use of an acrylic pressure-sensitive adhesive with a thickness of 20 μm for the pressure-sensitive adhesion layer 100 in place of an acrylic pressure-sensitive adhesive with a thickness of 10 μm, the surface luminous body of Comparative Example 2 was prepared. The embedding depth was measured immediately after the prism array sheet 10A was adhered to the light outgoing surface 21a of the surface luminous element 20 and a mean value of 6 μm was obtained and the average thickness of the pressure-sensitive adhesion layer between the ends of the prism and the light outgoing surface of the surface luminous element was 70% of the total thickness of the pressure-sensitive adhesion layer. Assuming that the front brightness and light take-out efficiency of the surface luminous body were 1 when the prism array sheet 10A was not adhered, the front brightness of the surface luminous body of Comparative Example 2 was 1.8 and the light take-out efficiency was 1.35.

### [Evaluation for Preservation Stability]

The tests of preservation at 85° C. for 500 hours and at 90% humidity and 60° C. for 500 hours were conducted on the luminous elements of Examples 1 to 5 and Comparative Examples 1 and 2 and the change in the external form and change in the front brightness were measured for them and were compared as the evaluation for preservation stability.

The surface luminous elements relating to Examples 1 to 5 had almost no change in the external form and the surface luminous element relating to Example 3 had almost no change in the front brightness. The surface luminous elements relating to Examples 1 and 2 were deteriorated in the front brightness respectively by about 3% and about 2%. Further, in the surface luminous elements relating to Examples 4 and 5, in the periphery of the prism array sheet, a slight change was observed in the embedding depth of the prism array sheet and the front brightness was deteriorated respectively by about 7% and about 5%. On the other hand, in the surface luminous elements of Comparative Examples 1 and 2, the embedding depth of the prism array sheet was increased remarkably and the front brightness was deteriorated respectively by about 12% and about 20%.

### [Evaluation for External Pressure Stability]

Furthermore, to the luminous elements of Examples 1 to 5 and Comparative Examples 1 and 2, a load of 2×10⁵ Pa was applied in an area of 1 cm square on the prism array sheet, and changes in the external form and front brightness were measured, and the results were compared as the evaluation for external pressure stability.

The surface luminous elements relating to Examples 1 to 3 had almost no change in the external form and had almost no change in the front brightness. In the surface luminous elements relating to Examples 4 and 5, a slight increase was observed in the embedding depth of the prism array sheet on the loaded portion thereof and the front brightness was deteriorated respectively by about 4% and about 2%. On the other hand, in the surface luminous elements of Comparative Examples 1 and 2, the embedding depth of the prism array sheet was increased remarkably and the front brightness was deteriorated respectively by about 13% and about 25%.

The surface luminous body relating to the present invention was excellent in the high temperature resistance and high humidity resistance, and even after the preservation stability tests, kept a high light take-out efficiency and high front brightness, and was excellent in the external pressure resistance.

Next, the surface luminous bodies relating to Examples 1 to 5 of the present invention were used in place of the built-in backlight of 15 type display VL-150SD by FUJITSU which was a VA-type liquid crystal display device and it was found that a liquid crystal display device having excellent brightness was obtained.

According to the present invention, a surface luminous body can be provided in which the take-out efficiency of light outgoing from the surface luminous body and front brightness are improved greatly, and furthermore, the credibility of adhesion between the light regulating sheet and the surface luminous element is enhanced, and the shock resistance is excellent, and even when external pressure is applied, the durability is high.

Further, the protrusions are embedded in the adhesion layer, thus the optical effect of the embedded portion of the protrusions is reduced, so that the influence on the optical performance by variations in the shape and embedding depth of the protrusions embedded in the adhesion layer is reduced. Generally, in the manufacture of the light regulating sheet, it is difficult to prepare accurately the shape of the neighborhood of the top of each of the protrusions, thus the fact that the influence on the performance of the surface luminous body by variations in the shape of the protrusions is slight in the present invention improves the easiness of manufacture. Further, by embedding, an effect of stabilizing the adhesion condition is obtained.

Further, a surface luminous body having uniform optical characteristics for reducing variations in the embedding depth of the protrusions caused by uneven adhesion pressure at the adhesion step when using the pressure-sensitive adhesive as a pressure-sensitive adhesion layer in contact with the light regulating sheet and reducing optical irregularities can be provided.

Further, a surface luminous body having a sufficient adhesive strength by setting the protrusion embedding depth into the adhesion layer within a stable area, even when it is preserved in an environment of high temperature and high humidity and furthermore even when it is applied with an external pressure after adhesion for reducing changes in the prism embedding depth and stabilizing the light take-out efficiency and front brightness can be provided.

What is claimed is:

1. A surface luminous body comprising:
a surface luminous element having a light outgoing surface;
an adhesion layer having one or more pressure-sensitive adhesion layers including one or more types of pressure-sensitive adhesive; and
a light regulating sheet having a plurality of protrusions on at least one surface thereof, ends of the protrusions being in contact with the light outgoing surface via the adhesion layer,
wherein a part of each of the ends is embedded in the adhesion layer and an average thickness of the one or more pressure-sensitive adhesion layers between the ends and the light outgoing surface is less than 50% of a total thickness of the one or more pressure-sensitive adhesion layers.

2. The surface luminous body of claim 1,
wherein the adhesion layer comprises:
a first pressure-sensitive adhesion layer which is in contact with the surface luminous element and which has one or more types of pressure-sensitive adhesive;
one or more resin layers; and
a second pressure-sensitive adhesion layer which is in contact with the light regulating sheet and which has one or more types of pressure-sensitive adhesive.

3. The surface luminous body of claim 2,
wherein the first pressure-sensitive adhesion layer and the second pressure-sensitive adhesion layer have different prism embedding loads.

4. The surface luminous body of claim 1,
wherein each of the protrusions is circular truncated cone shaped.

5. A manufacturing method of a surface luminous body including a surface luminous element having a light outgoing surface and a light regulating sheet having a plurality of protrusions at least on one side thereof, the manufacturing method comprising the steps of:
adhering ends of the protrusions and the light outgoing surface to each other via an adhering layer including one or more pressure-sensitive adhesion layers while a part of each of the ends is embedded in the adhering layer; and
embedding the part of each of ends deeper in the adhering layer by heating.

6. A surface luminous body produced according to the manufacturing method of claim 5.

7. A display device employing the surface luminous body of claim 1.

8. A display device employing the surface luminous body of claim 6.

9. An illuminating device employing the surface luminous body of claim 1.

10. An illuminating device employing the surface luminous body of claim 6.
